(19) United States
(12) Patent Application Publication
(10) Pub. No.: US 2012/0070084 A1
(43) Pub. Date: Mar. 22, 2012

(54) IMAGE PROCESSING APPARATUS, IMAGE PROCESSING METHOD, AND IMAGE PROCESSING PROGRAM

(75) Inventor: Shanshan YU, Kawasaki (JP)

(73) Assignee: FUJITSU LIMTED, Kawasaki (JP)

(21) Appl. No.: 13/243,131

(22) Filed: Sep. 23, 2011

Related U.S. Application Data
(63) Continuation of application No. PCT/JP2009/056584, filed on Mar. 30, 2009.

(51) Int. Cl. G06K 9/46

(52) U.S. Cl. 382/170; 382/190

(57) ABSTRACT

An image processing apparatus calculates luminances for pixels that make up an image and calculates the average luminance of the calculated luminances. From among pixels of the calculated luminances, the image processing apparatus identifies each of the luminances that has a value equal to or greater than a distinguishing value and calculates a bright-portion ratio of the identified luminance in the image. The image processing apparatus creates a luminance histogram and calculates a distribution value indicating a distribution level of the luminance distribution in a region corresponding to a luminance having a value equal to or greater than the distinguishing value in the created luminance histogram. The image processing apparatus determines whether the average luminance is equal to or less than a first threshold, whether the bright-portion ratio is equal to or greater than a second threshold, and whether the distribution value is equal to or greater than a third threshold.

### CROSS-REFERENCE TO RELATED APPLICATION(S)

This application is a continuation of International Application No. PCT/JP2009/056584, filed on Mar. 30, 2009, the entire contents of which are incorporated herein by reference.

### FIELD

The embodiments discussed herein are directed to an image processing apparatus, an image processing method, and an image processing program.

### BACKGROUND

Conventionally, various studies have been released on technology that determines whether an image captured by a digital camera, or the like, is of a night scene. For example, there is a known conventional technology for determining whether images are night scene images by using, in combination, luminance information and location information or luminance information and saturation information. Furthermore, for example, there is also a known conventional technology for determining whether images in which a person is captured are night scene images.

The night scene images mentioned here mean images that are preferably all dark; however, various types of images are considered to be overall dark images. Examples of such dark images include dark images across which some bright portions are scattered or include night scene images in which illuminations, such as fireworks, are scattered across a dark background image. Furthermore, for example, there are also dark images that have a large bright portion, such as a night scene image captured where a large white signboard is present against a dark background. Furthermore, for example, there are also dark images that do not have a bright portion at all, such as a night scene image of a night forest. A person usually imagines a dark image to be a night scene image across which bright portions are scattered.

Patent Document 1: Japanese Laid-open Patent Publication No. 2001-100087

Patent Document 2: Japanese Laid-open Patent Publication No. 2001-036744

Patent Document 3: Japanese Laid-open Patent Publication No. 2002-232728

Patent Document 4: Japanese Laid-open Patent Publication No. 2005-122720

Patent Document 5: Japanese Laid-open Patent Publication No. 2002-369075

Patent Document 6: Japanese Laid-open Patent Publication No. 2003-073505

However, with a conventional technology, it is not possible to determine whether an image, from among night scene images, is a dark image in which bright portions are scattered. Specifically, from among various types of night scene images, it is not possible to precisely determine whether an image that is imagined by a person as a night scene image is a night scene image.

### SUMMARY

According to an aspect of an embodiment of the invention, an image processing apparatus includes a luminance calculating unit that calculates luminances for pixels that make up an image; an average calculating unit that calculates an average luminance of the luminances calculated by the luminance calculating unit; a ratio calculating unit that identifies, from among the luminances calculated by the luminance calculating unit, each of the luminances that has a value equal to or greater than a distinguishing value that functions to distinguish a bright portion from a dark portion in the image and, that calculates a ratio of bright-portion luminances to all of the luminances calculated by the luminance calculating unit; a distribution calculating unit that calculates, in accordance with the luminances calculated by the luminance calculating unit, a distribution value indicating a dispersion level of a luminance distribution of pixels whose luminance is equal to or greater than the distinguishing value; and a determining unit that performs a determination determining whether the average luminance calculated by the average calculating unit is equal to or less than a first threshold, whether the bright-portion ratio calculated by the ratio calculating unit is equal to or greater than a second threshold, and whether the distribution value calculated by the distribution calculating unit is equal to or greater than a third threshold.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram illustrating the outline of an image processing apparatus according to a first embodiment;

FIG. 2 is a block diagram illustrating the configuration of the image processing apparatus according to the first embodiment;

FIG. 3 is a schematic diagram illustrating a threshold storing unit according to the first embodiment;

FIG. 4 is a schematic diagram illustrating a luminance calculating unit according to the first embodiment;

FIG. 5 is a schematic diagram illustrating a distinguishing value according to the first embodiment;

FIG. 6A is a schematic diagram illustrating a distribution value calculating unit according to the first embodiment;

FIG. 6B is a schematic diagram illustrating the distribution value calculating unit according to the first embodiment;

FIG. 7 is a schematic diagram illustrating the relation between the type of images and thresholds according to the first embodiment;

FIG. 8 is a flowchart illustrating an example of the flow of a process performed by the image processing apparatus according to the first embodiment;

FIG. 9 is a flowchart illustrating an example of the flow of a ratio calculating process performed by a ratio calculating unit according to the first embodiment;

FIG. 10A is a schematic diagram illustrating an example of an effect of the image processing apparatus according to the first embodiment;

FIG. 10B is a schematic diagram illustrating an example of an effect of the image processing apparatus according to the first embodiment;

FIG. 100 is a schematic diagram illustrating an example of an effect of the image processing apparatus according to the first embodiment;

FIG. 11A is a schematic diagram illustrating an example of an effect of the image processing apparatus according to the first embodiment;

FIG. 11B is a schematic diagram illustrating an example of an effect of the image processing apparatus according to the first embodiment;

FIG. 12 is a block diagram illustrating the configuration of an image processing apparatus according to a second embodiment;

FIG. 13 is a flowchart illustrating an example of the flow of a process performed by the image processing apparatus according to the second embodiment;

FIG. 14 is a block diagram illustrating the configuration of an image processing apparatus according to a third embodiment;

FIG. 15 is a flowchart illustrating an example of the flow of a process performed by the image processing apparatus according to the third embodiment and

FIG. 16 is a schematic diagram illustrating a computer that executes an image processing program according to the first embodiment.

### DESCRIPTION OF EMBODIMENTS

Preferred embodiments of the present invention will be explained with reference to accompanying drawings. In the following, the outline of the image processing apparatus according to the embodiments, the configuration of the image processing apparatus, and the flow of the processing thereof will be described in the order they are listed in this sentence. Subsequently, another embodiment will be described.

### [a] First Embodiment

### Outline of the Image Processing Apparatus

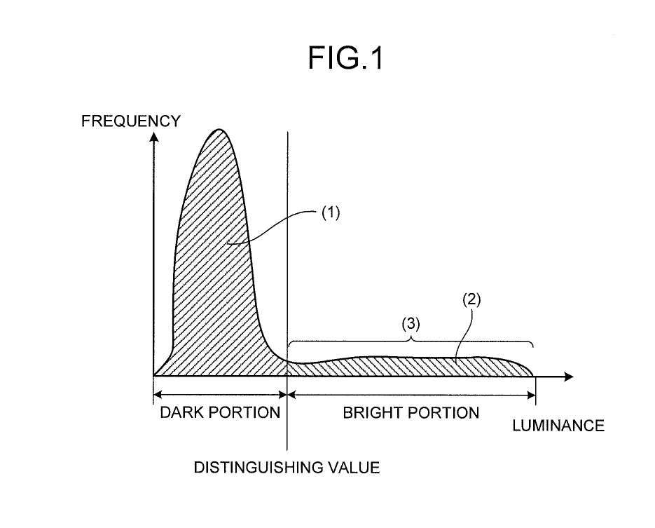

First, the outline of an image processing apparatus according to a first embodiment will be described with reference to FIG. 1. FIG. 1 is a schematic diagram illustrating the outline of the image processing apparatus according to the first embodiment.

The image processing apparatus according to the first embodiment calculates luminances for pixels that make up an image. For example, when the image processing apparatus receives image data captured by, for example, a digital camera, the image processing apparatus calculates luminances for pixels that make up the received image data and creates a luminance histogram, as illustrated in FIG. 1.

Then, the image processing apparatus according to the first embodiment calculates an average luminance of the calculated luminances. Furthermore, the image processing apparatus identifies, from among the calculated luminances, each of the luminances that has a value equal to or greater than a distinguishing value that functions to distinguish a bright portion from a dark portion in an image. Then, the image processing apparatus calculates a ratio of the number of the identified bright-portion luminances to the total number of calculated luminances. For example, as illustrated in FIG. 1, the image processing apparatus calculates the ratio of the total value of the frequencies of the pixels in the bright portion to the total value of the frequencies of the pixels in the entire luminance histogram. Furthermore, similarly, the image processing apparatus identifies the luminance having a value equal to or less than the distinguishing value in order to calculate a ratio of the dark portion.

Furthermore, for a region corresponding to the luminances having a value equal to or greater than the distinguishing value in the luminance histogram, the image processing apparatus according to the first embodiment calculates a distribution value indicating the dispersion level of the luminance distribution. For example, for the bright portion illustrated in FIG. 1, the image processing apparatus calculates a value indicating whether the luminance is widely distributed or whether the luminance is concentrated on a specific luminance range.

Then, the image processing apparatus according to the first embodiment determines whether the average luminance is equal to or less than a first threshold, whether the bright-portion ratio is equal to or greater than a second threshold, whether the distribution value is equal to or greater than a third threshold, and whether the dark-portion ratio is equal to or greater than a fourth threshold. If all of the thresholds are satisfied, the image processing apparatus determines that an image is a dark image across which bright portions are scattered.

Specifically, by determining whether the average luminance of the image is lower than the first threshold, the image processing apparatus excludes a “bright image”. Furthermore, as illustrated in (1) of FIG. 1, by determining whether a large number of pixels are present in a dark portion, the image processing apparatus excludes a “dark image that has a large bright portion”. Furthermore, as illustrated in (2) of FIG. 1, by determining that a certain amount of bright pixels are present in an image and a bright portion is present in the image, the image processing apparatus excludes a “dark image that does not have a bright portion”. Furthermore, as illustrated in (3) of FIG. 1, by determining whether bright pixels are widely distributed in a luminance range, the image processing apparatus precisely exclude a “dark image that does not have a bright portion” or a “dark image that has a large bright portion” and determine whether an image is a “dark image across which bright portions are scattered”.

By doing so, the image processing apparatus according to the first embodiment determine whether an image is a dark image across which bright portions are scattered. Furthermore, according to the present embodiment, it is possible to perform the determination with a small amount of calculation using only the luminances; therefore, it is possible to reduce the processing load for the determining process.

### Configuration of the Image Processing Apparatus

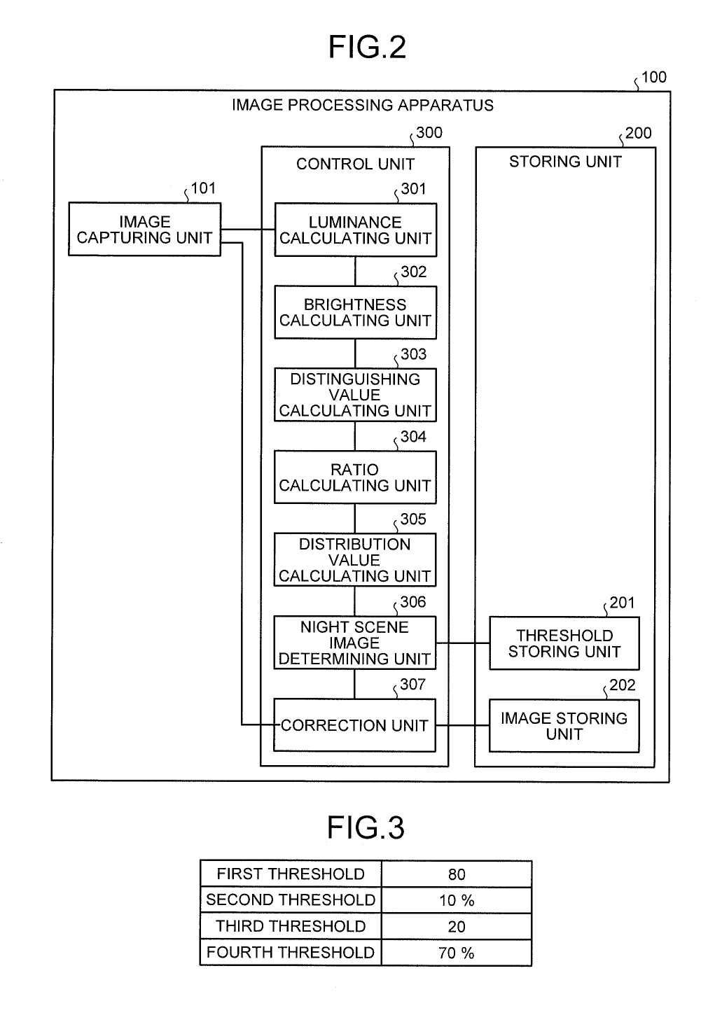

In the following, the configuration of an image processing apparatus 100 will be described with reference to FIG. 2. FIG. 2 is a block diagram illustrating the configuration of the image processing apparatus according to the first embodiment. As illustrated in FIG. 2, the image processing apparatus 100 includes an image capturing unit 101, a storing unit 200, and a control unit 300.

The image capturing unit 101 is connected to the control unit 300. Specifically, the image capturing unit 101 is connected to a luminance calculating unit 301 and a correction unit 307, which will be described later. The image capturing unit 101 corresponds to a digital camera or a digital video camera. If the image capturing unit 101 captures an image, the image capturing unit 101 transmits the captured image to the luminance calculating unit 301 and the correction unit 307. If the image capturing unit 101 receives an instruction from, for example, a user who is using the image processing apparatus 100, the image capturing unit 101 captures an image.

The storing unit 200 is connected to the control unit 300 and stores therein data used for various determining processes performed by the control unit 300. As illustrated in FIG. 2, the storing unit 200 includes a threshold storing unit 201 and an image storing unit 202.

The threshold storing unit 201 is connected to a night scene image determining unit 306 that will be described later. As illustrated in FIG. 3, the threshold storing unit 201 stores therein thresholds that are used in the determining process performed by the night scene image determining unit 306. FIG. 3 is a schematic diagram illustrating the threshold storing unit according to the first embodiment.

In the example illustrated in FIG. 3, the threshold storing unit 201 stores therein four thresholds: a first threshold “80”, a second threshold “10%”, a third threshold “20”, and a fourth threshold “70%”. Each of the thresholds stored by the threshold storing unit 201 are thresholds related to a feature value that is calculated by using only luminances or luminance spectra without using information other than the luminances nor the luminance spectra.

Furthermore, each of the thresholds stored by the threshold storing unit 201 is used in the determining process performed by the night scene image determining unit 306. Specifically, the thresholds are used in a process performed for determining whether an image captured by the image capturing unit 101 is a “dark image across which bright portions are scattered”. More specifically, if each of the thresholds stored by the threshold storing unit 201 is a feature value calculated from the luminances or the luminance spectra of the “dark image across which bright portions are scattered”, the night scene image determining unit 306, which will be described later, determines that the thresholds are satisfied in the determining process.

Each of the thresholds will be described in detail later together with a description of the night scene image determining unit 306; therefore, a description thereof will be omitted here. In the threshold storing unit 201, for example, a user previously stores therein a threshold. The threshold stored in the threshold storing unit 201 is used by the night scene image determining unit 306.

The image storing unit 202 is connected to the correction unit 307. Furthermore, the image storing unit 202 stores therein an image captured by the image capturing unit 101. Specifically, the image storing unit 202 stores therein an image corrected by the correction unit 307.

The control unit 300 is connected to the image capturing unit 101 and the storing unit 200 and includes an internal memory for storing programs prescribing various kinds of procedures for the determining process, and performs various kinds of determining processes. Furthermore, the control unit 300 includes the luminance calculating unit 301, a brightness calculating unit 302, a distinguishing value calculating unit 303, a ratio calculating unit 304, a distribution value calculating unit 305, the night scene image determining unit 306, and the correction unit 307.

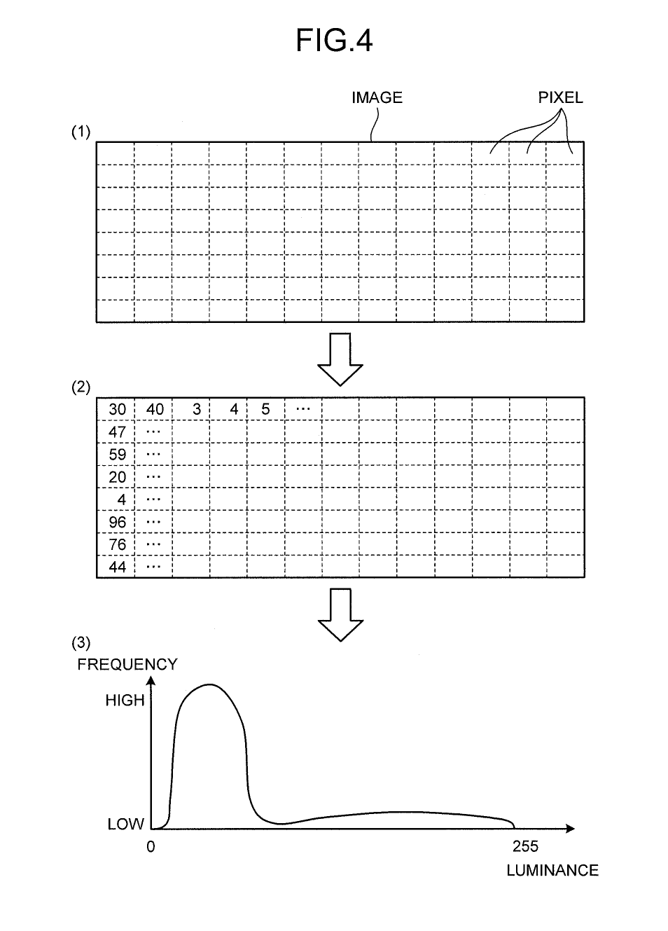

The luminance calculating unit 301 is connected to the image capturing unit 101 and the brightness calculating unit 302. As illustrated in FIG. 4, if the luminance calculating unit 301 receives an image from the image capturing unit 101, the luminance calculating unit 301 calculates luminances for pixels that make up an image. FIG. 4 is a schematic diagram illustrating a luminance calculating unit according to the first embodiment.

As illustrated in (1) of FIG. 4, for pixels that make up an image, the luminance calculating unit 301 calculates luminances, as illustrated in (2) of FIG. 4. For example, in the example illustrated in (2) of FIG. 4, the luminance calculating unit 301 calculates luminances “30, 40, 3, 4, 5 . . . ”.

Furthermore, as illustrated in (3) of FIG. 4, the luminance calculating unit 301 creates a luminance histogram. In the luminance histogram illustrated in (3) of FIG. 4 as an example, the lateral axis represents the luminance and the vertical axis represents the frequency of the pixels. Furthermore, FIG. 4 illustrates a case in which brightness and darkness of the luminances are represented using values from “0” to “255”: 256 grayscale levels.

When calculating the luminances for pixels that make up an image, the luminance calculating unit 301 transmits the calculated luminances or the luminance histogram to the brightness calculating unit 302. Here, the luminances or the luminance histogram that is transmitted from the luminance calculating unit 301 to the brightness calculating unit 302 does not contain location information indicating which pixel of the luminance is calculated from among pixels that make up an image. Specifically, the luminance calculating unit 301 transmits the calculated luminances “30, 40, 3, 4, 5 . . . ” without adding anything or transmits only the luminance histogram illustrated in (3) of FIG. 4 to the brightness calculating unit 302.

It is also possible for the luminance calculating unit 301 to reduce the size of the image captured by the image capturing unit 101 and to calculate the luminances for pixels that make up the reduced image. Specifically, instead of using the image received from the image capturing unit 101, a process for creating an image in which the number of pixels is reduced may also be performed. This makes it possible to reduce the number of luminances used by each unit in the control unit 300; therefore the processing load may be reduced. The control unit 300 will be described later.

The brightness calculating unit 302 is connected to the luminance calculating unit 301 and the distinguishing value calculating unit 303 and calculates a brightness value indicating the brightness of the entire image captured by the image capturing unit 101. Specifically, if the brightness calculating unit 302 receives luminances or a luminance histogram from the luminance calculating unit 301, the brightness calculating unit 302 calculates an average luminance of the luminances calculated by the luminance calculating unit 301.

For example, the brightness calculating unit 302 calculates, using “Equation (1)” below, the average luminance of the luminances calculated by the luminance calculating unit 301. As illustrated in “Equation (1)”, if the luminances “30, 40, 3, 4, 5 . . . ” are calculated by the luminance calculating unit 301, the brightness calculating unit 302 calculates the average luminance by dividing the total value of the calculated luminance by the number of calculated luminances. For example, the brightness calculating unit 302 calculates the average luminance “60”.

$$average luminance = \frac{\sum pixel value}{total number of pixels} \qquad ( 1 )$$

Furthermore, for example, by using the luminance histogram calculated by the luminance calculating unit 301 the brightness calculating unit 302 calculates, using “Equation (2)” below, the average luminance. As illustrated in “Equation (2)”, for each of the luminances from “0” to “255”, the brightness calculating unit 302 calculates a value by multiplying the frequency of the pixels H(i) of the luminance (i) by the luminance (i). Then, the brightness calculating unit 302 calculates the average luminance by dividing the total value of the obtained multiplied value by the total number of pixels. The total number of pixels mentioned here means the total value of the frequency of the pixels H corresponding to luminances represented from “0” to “255” and indicates, for example, the number of pixels of the luminances calculated by the luminance calculating unit 301.

$$average luminance = \frac{{\sum }_{i = 0}^{255} i \cdot H ( i )}{total number of pixels} \qquad ( 2 )$$

Furthermore, when the brightness calculating unit 302 calculates the average luminance, the brightness calculating unit 302 transmits, in addition to the luminances or the luminance histogram received from the luminance calculating unit 301, the average luminance to the distinguishing value calculating unit 303. For example, the brightness calculating unit 302 transmits the average luminance “60” to the distinguishing value calculating unit 303.

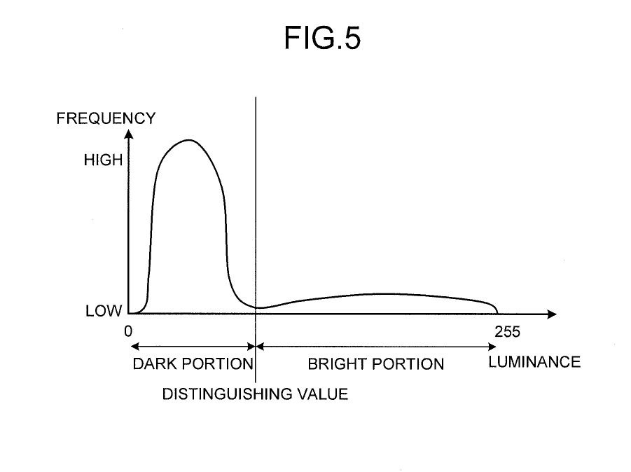

The distinguishing value calculating unit 303 is connected to the brightness calculating unit 302 and the ratio calculating unit 304. Furthermore, when receiving the luminances, the luminance histogram, or the average luminance from the brightness calculating unit 302, the distinguishing value calculating unit 303 calculates a distinguishing value. As illustrated in FIG. 5, the distinguishing value represents a luminance that distinguish a bright portion from a dark portion in an image. FIG. 5 is a schematic diagram illustrating a distinguishing value according to the first embodiment.

For example, by using the luminance histogram created by the luminance calculating unit 301, the distinguishing value calculating unit 303 calculates the distinguishing value in accordance with the ratio of the frequency of the pixels at the peak of the dark portion to the frequency of the pixels at the peak of the bright portion of the luminance histogram of the image (Japanese Laid-open Patent Publication No. 2001-036744). For example, the distinguishing value calculating unit 303 calculates the distinguishing value “50”.

The distinguishing value calculating unit 303 may also use, as the distinguishing value, the average luminance calculated by the brightness calculating unit 302. Furthermore, the distinguishing value calculating unit 303 may also use, as the distinguishing value, a value obtained by subtracting a predetermined value from the average luminance. For example, the distinguishing value calculating unit 303 may also use, as the distinguishing value, a luminance value obtained by subtracting 20% of the average luminance. Furthermore, instead of calculating the distinguishing value, the distinguishing value calculating unit 303 may also use, as the distinguishing value, a value previously set by a user.

Furthermore, in addition to the luminances, the luminance histogram, or the average luminance received from the brightness calculating unit 302, the distinguishing value calculating unit 303 transmits the distinguishing value to the ratio calculating unit 304. For example, the distinguishing value calculating unit 303 transmits the distinguishing value “70”.

The ratio calculating unit 304 is connected to the distinguishing value calculating unit 303 and the distribution value calculating unit 305. When receiving the luminances, the luminance histogram, the average luminance, or the distinguishing value from the distinguishing value calculating unit 303, the ratio calculating unit 304 calculates the bright-portion ratio or the dark-portion ratio.

The bright-portion ratio mentioned here means the ratio of pixels, from among pixels that make up an image, indicating the luminances having a value equal to or greater than the distinguishing value to all of the pixels that make up the image. The dark-portion ratio mentioned here means the ratio of pixels, from among pixels that make up an image, indicating the luminances having a value equal to or less than the distinguishing value to all of the pixels that make up the image.

Specifically, from among luminances calculated by the luminance calculating unit 301, the ratio calculating unit 304 identifies the number of luminances having a value equal to or greater than the distinguishing value. Then, the ratio calculating unit 304 calculates the bright-portion ratio of the number of luminances calculated by the luminance calculating unit 301 to the number of identified luminances. Furthermore, similarly, the ratio calculating unit 304 identifies the number of luminances having a value equal to or less than the distinguishing value and calculates the dark-portion ratio of the number of luminances calculated by the luminance calculating unit 301 to the number of identified luminances.

As illustrated in “Equation (3)” or “Equation (4)”, the ratio calculating unit 304 calculates the dark-portion ratio or the bright-portion ratio using the luminance histogram.

$$\begin{matrix}dark \text{-} portion ratio = \frac{{\sum }_{i = 0}^{distinguishing value} H ( i )}{total number of pixels} & ( 3 ) \\ bright \text{-} portion ratio = \frac{{\sum }_{i = distinguishing value + 1}^{255} H ( i )}{total number of pixels} = 1 - dark \text{-} portion ratio & ( 4 )\end{matrix}$$

For example, as illustrated in “Equation (3)”, when calculating the dark-portion ratio, the ratio calculating unit 304 calculates, for the luminances from “0” to the distinguishing value, a value by multiplying the frequency of the pixels H(i) of the luminance (i) by the luminance (i). Specifically, the ratio calculating unit 304 calculates the total value of the frequency of the pixels in the “dark portion” illustrated in FIG. 5. Then, by dividing the total value of the calculated values by the total number of pixels, the brightness calculating unit 302 calculates the dark-portion ratio. For example, the ratio calculating unit 304 calculates the dark-portion ratio “80%”.

Furthermore, for example, when calculating the bright-portion ratio, as illustrated in “Equation (4)”, the ratio calculating unit 304 calculates, for the luminances from the “distinguishing value+1” to “255”, a value by multiplying the frequency of the pixels H(i) of the luminance (i) by the luminance (i). Specifically, the ratio calculating unit 304 calculates the total value of the frequency of the pixels in the “bright portion” illustrated in FIG. 5. Then, the brightness calculating unit 302 calculates the bright-portion ratio by dividing the total value of the calculated values by the total number of pixels. For example, the ratio calculating unit 304 calculates the bright-portion ratio “20%”.

As illustrated in “Equation (4)”, if the dark-portion ratio has already been calculated, the brightness calculating unit 302 may also calculate the bright-portion ratio by subtracting the calculated dark-portion ratio from

The ratio calculating unit 304 may also calculate the dark-portion ratio or the bright-portion ratio without using the luminance histogram. For example, by determining whether each of the received luminances has a value equal to or greater than the distinguishing value or a value equal to or less than the distinguishing value, the ratio calculating unit 304 calculates the number of luminances having a value equal to or greater than the distinguishing value or calculates the number of luminances having a value equal to or less than the distinguishing value. Then, the ratio calculating unit 304 calculates the bright-portion ratio or the dark-portion ratio by dividing the number of luminances having a value equal to or greater than the distinguishing value by the total number of pixels or by dividing the number of luminances having a value equal to or less than the distinguishing value by the total number of pixels. The flow of a process that uses the received luminances to calculate the bright-portion ratio and the dark-portion ratio will be described in detail later; therefore, a description thereof will be omitted here.

When calculating the bright-portion ratio or the dark-portion ratio, the ratio calculating unit 304 transmits, to the distribution value calculating unit 305, the dark-portion ratio or the bright-portion ratio in addition to the luminances, the luminance histogram, the average luminance, and the distinguishing value received from the distinguishing value calculating unit 303. For example, the ratio calculating unit 304 transmits the dark-portion ratio “80%” and the bright-portion ratio “20%”.

The distribution value calculating unit 305 is connected to the ratio calculating unit 304 and the night scene image determining unit 306. When receiving the luminances, the luminance histogram, the average luminance, the distinguishing value, the dark-portion ratio or the bright-portion ratio from the ratio calculating unit 304, the distribution value calculating unit 305 calculates, using the luminance histogram, the distribution value indicating the dispersion level of the luminance distribution in the luminance range corresponding to the luminances having a value equal to or greater than the distinguishing value. For example, the distribution value calculating unit 305 calculates the distribution value “20”.

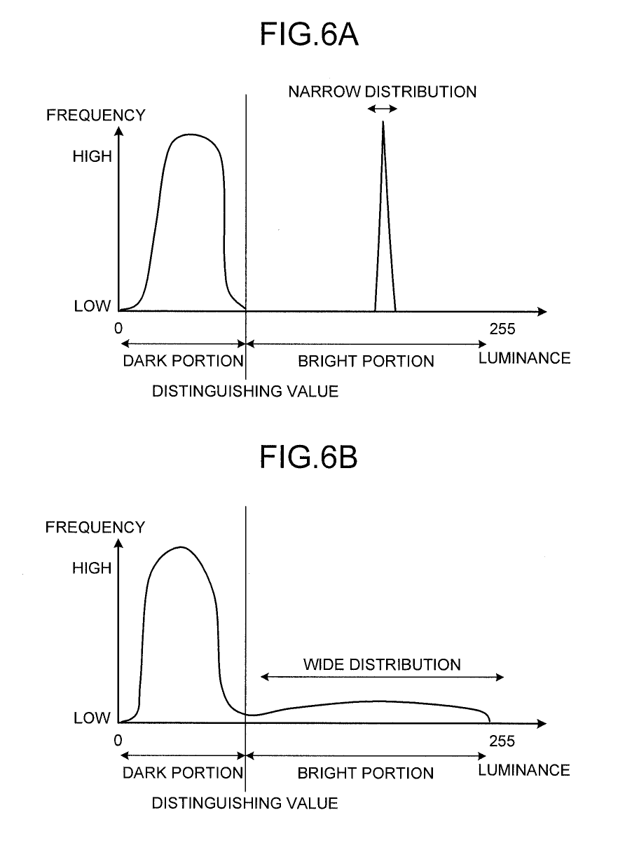

Specifically, as illustrated in the “bright portion” in FIG. 6A, the distribution value calculating unit 305 calculates, as the distribution value, a smaller value as the distribution of the frequency of the pixels becomes more concentrated on the luminances in a certain range in the luminance range corresponding to the luminances having a value equal to or greater than the distinguishing value. Furthermore, for example, as illustrated in the “bright portion” in FIG. 6B, the distribution value calculating unit 305 calculates, as the distribution value, a greater value as the distribution of the frequency of the pixels becomes dispersed in a wider range in the luminance range corresponding to the luminances having a value equal to or less than the distinguishing value. FIG. 6A is a schematic diagram illustrating a distribution value calculating unit according to the first embodiment. FIG. 6B is a schematic diagram illustrating the distribution value calculating unit according to the first embodiment.

For example, the distribution value calculating unit 305 calculates the distribution value by using “Equation (5)” or “Equation (6)” illustrated below. The “distribution value” mentioned here is not limited to the mathematical “variance” as long as the value indicates the dispersion level of the distribution described below. In the example illustrated in “Equation (5)” or “Equation (6)”, for luminances from “distinguishing value plus 1” to “255”, the distribution value calculating unit 305 calculates the difference value between the average luminance and the luminance (i) in the bright portion. For example, the distribution value calculating unit 305 calculates the absolute value of (i minus the average luminance in a bright portion) or calculates a value of (i minus the average luminance in a bright portion) squared. Then, for the luminances from “distinguishing value plus 1” to “255”, the distribution value calculating unit 305 calculates a value by multiplying the difference value between the average luminance and the luminance (i) in the bright portion by the frequency of the pixels H(i) of the luminance (i). Then, the brightness calculating unit 302 calculates the distribution value by dividing the total value of the calculated values by the total frequency of the pixels that make up the bright portion. The total number of pixels that make up the bright portion corresponds to the total value of the frequency of the pixels in the bright portion.

$$\begin{matrix}distribution value = \frac{\begin{matrix}{\sum }_{i = distinguishing value + 1}^{255} {( i - average luminance in a bright portion )}^{2} \cdot \\ H ( i )\end{matrix}}{{\sum }_{i = distinguishing value + 1}^{255} H ( i )} & ( 5 ) \\ distribution value = \frac{\begin{matrix}{\sum }_{i = distinguish ing value + 1}^{255} \vert i - average luminance in a bright portion \vert \cdot \\ H ( i )\end{matrix}}{{\sum }_{i = distinguishing value + 1}^{255} H ( i )} & ( 6 )\end{matrix}$$

As illustrated in “Equation (5)” or “Equation (6)”, the value calculated for each luminance becomes a smaller value as the difference between the average luminance and the luminance (i) in the luminance range corresponding to the luminances having a value equal to or greater than the distinguishing value decreases, i.e., as the luminance get closer to the average luminance. Furthermore, the value calculated for each luminance becomes a greater value as the difference between the average luminance and the luminance (i) in the bright portion increases, i.e., as the luminance is further different from the average luminance. Accordingly, the distribution value increases as the frequency of the pixels with the luminances that are different from the average luminance increases.

For example, the distribution value calculating unit 305 calculates, using “Equation (7)” illustrated below, the average luminance in the luminance range corresponding to the luminances having a value equal to or greater than the distinguishing value. In the example illustrated in “Equation (7)”, for the luminances from “distinguishing value plus 1” to “255”, the distribution value calculating unit 305 calculates a value by multiplying the frequency of the pixels H(i) of the luminance (i) by the luminance (i). Then, the distribution value calculating unit 305 calculates the total value of the values calculated for the luminances from “distinguishing value plus 1” to “255”. Thereafter, by dividing the total value of the calculated values by the number of pixels that make up the bright portion, the distribution value calculating unit 305 calculates the average luminance in the bright portion.

$$average luminance in a bright portion = \frac{{\sum }_{i = distinguishing value + 1}^{255} i \cdot H ( i )}{{\sum }_{i = distinguishing value + 1}^{255} H ( i )} \qquad ( 7 )$$

The distribution value calculating unit 305 may also calculate the distribution value or the average luminance directly from each of the luminance values of the pixels without using the histogram. In such a case, the distribution value may be obtained by using, as the denominator, (the total number of pixels having a luminance value equal to or greater than the distinguishing value) and by using, as the numerator, the sum of the values of (the luminance value of the pixel whose luminance value is greater than the distinguishing value minus the average luminance of pixels whose luminance value is greater than the distinguishing value) squared.

The average luminance may be obtained by using, as the denominator, (the total number of pixels having a luminance value greater than the distinguishing value) and by using, as the numerator, the sum of the values of (the luminance value of the pixel whose luminance value is greater than the distinguishing value).

Furthermore, when calculating the distribution value, the distribution value calculating unit 305 transmits the distribution value to the night scene image determining unit 306 in addition to the average luminance, the bright-portion ratio, and the dark-portion ratio received from the ratio calculating unit 304. For example, the distribution value calculating unit 305 transmits the distribution value “20”.

The night scene image determining unit 306 is connected to the threshold storing unit 201, the distribution value calculating unit 305, and the correction unit 307. Furthermore, by referring to the threshold storing unit 201, the night scene image determining unit 306 determines whether the average luminance is equal to or less than the first threshold, whether the bright-portion ratio is equal to or greater than the second threshold, and whether the distribution value is equal to or greater than the third threshold. Furthermore, the night scene image determining unit 306 determines whether the dark-portion ratio is equal to or greater than the fourth threshold.

Specifically, by determining whether the average luminance is equal to or less than the first threshold, the night scene image determining unit 306 determines whether an image is an overall-dark image and then excludes a “bright image”. Furthermore, by determining whether the dark-portion ratio is equal to or greater than the fourth threshold, the night scene image determining unit 306 excludes a “dark image that has a large bright portion”. Furthermore, by determining whether the bright-portion ratio is equal to or greater than the second threshold, the night scene image determining unit 306 excludes a “dark image that does not have a bright portion”. Furthermore, by determining whether the distribution value is equal to or greater than the third threshold, the night scene image determining unit 306 excludes a “dark image that does not have a bright portion” or a “dark image that has a large bright portion”. Then, if the night scene image determining unit 306 determines that all of the thresholds are satisfied, the night scene image determining unit 306 determines that the image is a “dark image across which bright portions are scattered”.

In the following, each of the thresholds will be described in more detail. In some cases, a night scene image may be an image that is almost all dark. The first threshold is a threshold that is used to determine whether an image is a dark image. For example, if the maximum number of gradation levels is 256, the first threshold is set to a value equal to or less than 128. In the example illustrated in FIG. 3, the first threshold is set to “80”. Furthermore, in some cases, a night scene image may be an image that has bright pixels at a predetermined ratio; therefore, the second threshold is a threshold that is used to determine whether an image has bright pixels. For example, the second threshold is set in a range of “0% to 50%”. In the example illustrated in FIG. 3, the second threshold is set to “10%”. Furthermore, in some cases, a night scene image may be an image across which some bright pixels are scattered. For example, an image in which illuminations, such as fireworks, are scattered across a dark background image. In such an image, luminance values of bright pixels tend to have various values from a bright value to a dark value. The third threshold is a threshold that is used to determine whether the variance of a bright portion having such a tendency is large. For example, the third threshold is set in the range of “20% to 50%” of the distribution value that is obtained when pixels are uniformly scattered in the bright portion. In the example illustrated in FIG. 3, the third threshold is set to “20” when Equation (6) is used. Furthermore, in some cases, a night scene image may be an image in which the ratio of the dark portion is high; therefore the fourth threshold is a threshold that is used to determine whether the ratio of the dark portion is high. For example, the fourth threshold is set to a value equal to or greater than “50%”. In the example illustrated in FIG. 3, the fourth threshold is set to “70%”.

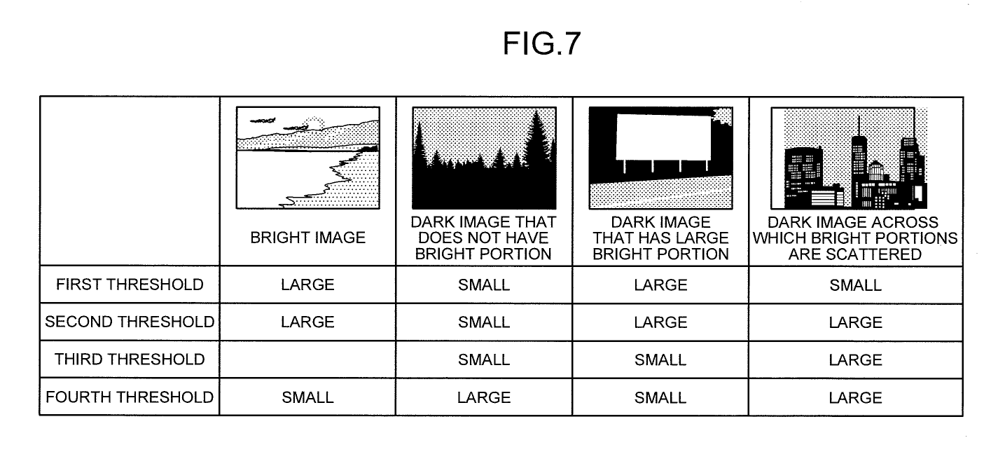

In the following, the relation between the type of night scene images and thresholds according to the first embodiment will be described with reference to FIG. 7. FIG. 7 is a schematic diagram illustrating the relation between the types of night scene image and thresholds according to the first embodiment. FIG. 7 illustrates, for each type of images, the relation between thresholds and the average luminance, the dark-portion ratio, the bright-portion ratio, and the distribution value. FIG. 7 illustrates, as examples of the types of image, a “bright image”, a “dark image that does not have a bright portion”, a “dark image that has a large bright portion”, and a “dark image across which bright portions are scattered”.

As illustrated in FIG. 7, if an image is a “bright image”, the average luminance becomes equal to or greater than the first threshold and the dark-portion ratio becomes equal to or less than the fourth threshold. Accordingly, the night scene image determining unit 306 excludes the “bright image” by using the first threshold or the fourth threshold. If an image is a “dark image that does not have a bright portion”, the bright-portion ratio becomes equal to or less than the second threshold and the distribution value becomes equal to or less than the third threshold. Accordingly, the night scene image determining unit 306 excludes the “dark image that does not have a bright portion” by using the second threshold or the third threshold. If an image is a “dark image that has a large bright portion”, the distribution value becomes equal to or less than the third threshold and the dark-portion ratio is equal to or less than the fourth threshold. Accordingly, the night scene image determining unit 306 excludes the “dark image that has a large bright portion” by using the third threshold or the fourth threshold.

In the following, the third threshold will further be described. First, a case will be described in which, if an image is a “dark image that does not have a bright portion”, the distribution value becomes equal to or less than the third threshold. Then, a case will be described in which, if an image is a “dark image that has a large bright portion”, the distribution value becomes equal to or less than the third threshold.

First, the “dark image that does not have a bright portion” will be described. As described above, the distribution value increases as the number of pixels with the luminances that are different from the average luminance increases. Almost no bright pixels are present in the “dark image that does not have a bright portion”; therefore, almost no pixels are present in the luminance range having the distinguishing value or more. Accordingly, the distribution value becomes equal to or less than the third threshold.

In the following, a “dark image that has a large bright portion” will be described. In the bright portion in the “dark image across which bright portions are scattered”, because the size of each of the bright portions is not large, the bright portions are not concentrated on the specific luminance. For example, as may be seen from illuminations, such as fireworks, luminance values range from a bright value to a dark value. In contrast, in the “dark image that has a large bright portion”, the bright portion is large. When compared with the “dark image across which bright portions are scattered”, the luminances are concentrated on the specific value in the “dark image that has a large bright portion”. For example, as may be seen from the dark image that includes a large white signboard, the luminances indicating the white signboard portion are concentrated on the specific value.

After the completion of the determination, the night scene image determining unit 306 transmits the determination result to the correction unit 307. For example, when determining an image to be a “dark image across which bright portions are scattered”, the night scene image determining unit 306 transmits the determination result indicating that the image is a “dark image across which bright portions are scattered”.

The correction unit 307 is connected to the image capturing unit 101, the image storing unit 202, and the night scene image determining unit 306. The correction unit 307 receives an image from the image capturing unit 101. When receiving the determination result from the night scene image determining unit 306, the correction unit 307 corrects the image using a correction method specified by the determination result. Then, the correction unit 307 stores the corrected image in the image storing unit 202.

For example, when receiving the determination result indicating that the image is a “dark image across which bright portions are scattered” from the night scene image determining unit 306, the correction unit 307 corrects the image by using a method for correcting a night scene image. For example, the correction unit 307 corrects the image by making it brighter or more vivid. Furthermore, for example, in accordance with the determination result received from the night scene image determining unit 306, if an image is the type of image that does not have to be corrected, the correction unit 307 does not perform a correction and stores the image received from the image capturing unit 101 in the image storing unit 202 without processing it.

Specifically, in accordance with the type of the night scene image specified by the determination result performed by the night scene image determining unit 306, the correction unit 307 changes correction methods. For example, if an image is determined to be a “dark image across which bright portions are scattered”, the correction unit 307 performs a correction to make the image brighter or more vivid. Furthermore, if an image is determined to be a “dark image that has a large bright portion”, e.g., a night scene image captured with a large white signboard present, the correction unit 307 does not correct, in principle, the image to avoid overexposure of the white signboard portion. Furthermore, if an image is determined to be a “dark image that does not have a bright portion”, e.g., a night scene image of a night forest, the correction unit 307 corrects the image in such a manner that it becomes brighter.

The image processing apparatus 100 may also be implemented by installing the functions of units illustrated in FIG. 2 in an information processing apparatus, such as a personal computer, a mobile phone, a personal handyphone system (PHS) terminal, and a mobile communication terminal.

### Process Performed By the Image Processing Apparatus

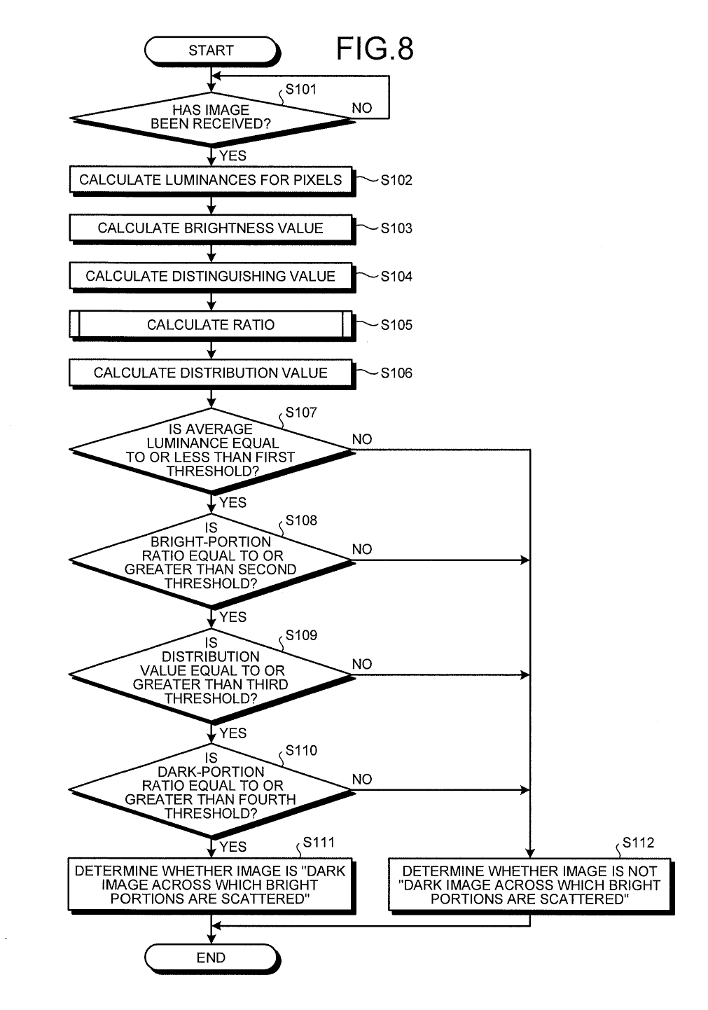

In the following, an example of the flow of a process performed by the image processing apparatus 100 according to the first embodiment will be described with reference to FIG. 8. FIG. 8 is a flowchart illustrating an example of the flow of a process performed by the image processing apparatus according to the first embodiment. FIG. 8 illustrates the flow of a process performed until the image processing apparatus 100 determines whether an image is a night scene image or not.

As illustrated in FIG. 8, in the image processing apparatus 100 according to the first embodiment, if the luminance calculating unit 301 receives an image from the image capturing unit 101 (Yes at Step S101), the luminance calculating unit 301 calculates luminances for pixels that make up an image (Step S102). For example, the luminance calculating unit 301 calculates the luminances “30, 40, 3, 4, 5 . . . ”.

Then, the brightness calculating unit 302 calculates the brightness value indicating the brightness of the image (Step S103). Specifically, the brightness calculating unit 302 calculates the average luminance of the luminances calculated by the luminance calculating unit 301. For example, the brightness calculating unit 302 calculates the average luminance “60”.

Then, the distinguishing value calculating unit 303 calculates the distinguishing value (Step S104). For example, the distinguishing value calculating unit 303 calculates, as the distinguishing value, a luminance value obtained by subtracting 20% of the average luminance. For example, the distinguishing value calculating unit 303 calculates the distinguishing value “50”.

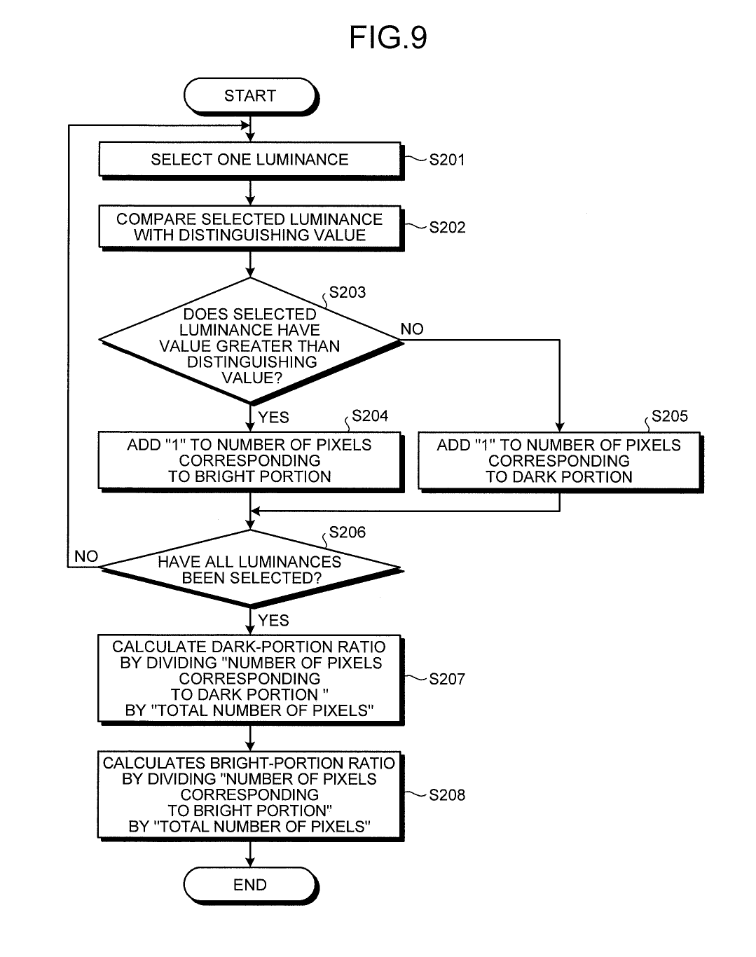

Then, the ratio calculating unit 304 calculates the bright-portion ratio or the dark-portion ratio (Step S105). For example, the ratio calculating unit 304 calculates the dark-portion ratio “80%” or the bright-portion ratio “20%”. An example of the flow of the ratio calculating process performed by the ratio calculating unit 304 will be described in detail later with reference to FIG. 9; therefore, a description thereof will be omitted here.

The distribution value calculating unit 305 calculates, using the luminance histogram, the distribution value that indicates the dispersion level of the luminance distribution in a bright portion (Step S106). For example, the distribution value calculating unit 305 calculates the distribution value “20%”.

By referring to the threshold storing unit 201, the night scene image determining unit 306 determines whether the average luminance is equal to or less than the first threshold (Step S107), whether the bright-portion ratio is equal to or greater than the second threshold (Step S108), and whether the distribution value is equal to or greater than the third threshold (Step S109). Furthermore, the night scene image determining unit 306 determines whether the dark-portion ratio is equal to or greater than the fourth threshold (Step S110).

If the night scene image determining unit 306 determines that all of the thresholds are satisfied (Yes at Steps 5107, S108, 5109, and S110), the night scene image determining unit 306 determines that the image is a “dark image across which bright portions are scattered” (Step S111). In contrast, if the night scene image determining unit 306 determines that any one of the thresholds is not satisfied (No at either Step S107, S108, 5109, or S110), the night scene image determining unit 306 determines that the image is not a “dark image across which bright portions are scattered” (Step S112).

### Process Performed By the Ratio Calculating Unit

In the following, an example of the flow of the ratio calculating process performed by the ratio calculating unit 304 according to the first embodiment will be described with reference to FIG. 9. FIG. 9 is a flowchart illustrating an example of the flow of the ratio calculating process performed by the ratio calculating unit according to the first embodiment. The flow of the process described with reference to FIG. 9 corresponds to Step S105 from among the processes that have been described using FIG. 8.

As illustrated in FIG. 9, when receiving the luminances calculated by the luminance calculating unit 301 from the distinguishing value calculating unit 303, the ratio calculating unit 304 selects one luminance from among the received luminances (Step S201) and compares it with the distinguishing value (Step S202). If the luminance has a value greater than the distinguishing value (Yes at Step S203), the ratio calculating unit 304 adds “1” to the number of pixels corresponding to the bright portion (Step S204). In contrast, if the luminance has a value lower than the distinguishing value (No at Step S203), the ratio calculating unit 304 adds “1” to the number of pixels corresponding to the dark portion (Step S205).

Then, the ratio calculating unit 304 determines whether all of the received luminances have been selected (Step S206). If the ratio calculating unit 304 determines that not all of the luminances have been selected (No at Step S206), the ratio calculating unit 304 repeats the processes at Steps S201 to S204.

Furthermore, if the ratio calculating unit 304 determines that all of the luminances are selected (Yes at Step S206), the ratio calculating unit 304 calculates the dark-portion ratio by dividing “the number of pixels corresponding to the dark portion” by “the total number of pixels” (Step S207). For example, if the number of pixels corresponding to the dark portion is “20” and if the total number of pixels is “100”, the ratio calculating unit 304 calculates the dark-portion ratio “20%”.

Then, the ratio calculating unit 304 calculates the bright-portion ratio by dividing “the number of pixels corresponding to the bright portion” by “the total number of pixels” (Step S208). For example, if the number of pixels corresponding to the bright portion is “80” and if the total number of pixels is “100”, the ratio calculating unit 304 calculates the bright-portion ratio “80%”.

### Advantage of the First Embodiment

As described above, according to the first embodiment, the image processing apparatus 100 calculates luminances for pixels that make up an image, calculates the average luminance, and calculates the bright-portion ratio. Furthermore, the image processing apparatus 100 creates the luminance histogram and calculates, in a region corresponding to the luminance having a value equal to or greater than the distinguishing value in the created luminance histogram, the distribution value indicating the dispersion level of the luminance distribution. Then, the image processing apparatus 100 determines whether the average luminance is equal to or less than the first threshold, whether the bright-portion ratio is equal to or greater than the second threshold, and whether the distribution value is equal to or greater than the third threshold. Accordingly, according to the first embodiment, it is possible to determine whether an image is a dark image across which bright portions are scattered. Furthermore, according to the present embodiment, after calculating the luminances, determination may be performed with a small amount of calculation using only the luminances without referring to the original image.

Furthermore, according to the first embodiment, because the image processing apparatus 100 calculates the dark-portion ratio and further determines whether the dark-portion ratio is equal to or greater than the fourth threshold, it is possible to precisely determine whether an image is a dark image across which bright portions are scattered.

Furthermore, according to the first embodiment, the image processing apparatus 100 calculate, using the luminance histogram, the average luminance, the bright-portion ratio, the dark-portion ratio, and the distribution value. By using only the luminance histogram, the image processing apparatus 100 calculate the feature value that is used to easily determine whether an image is a night scene image; therefore, the determination can be easily performed.

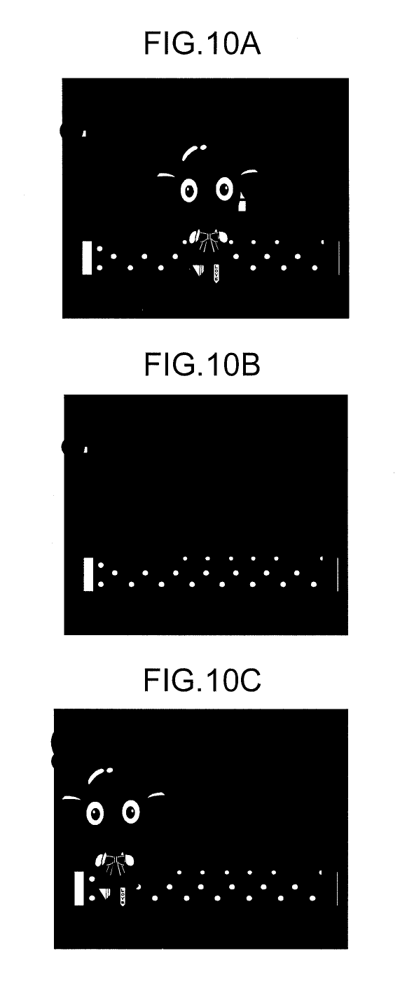

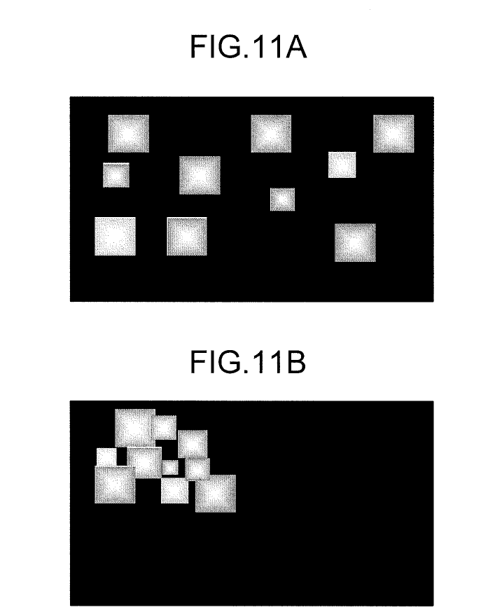

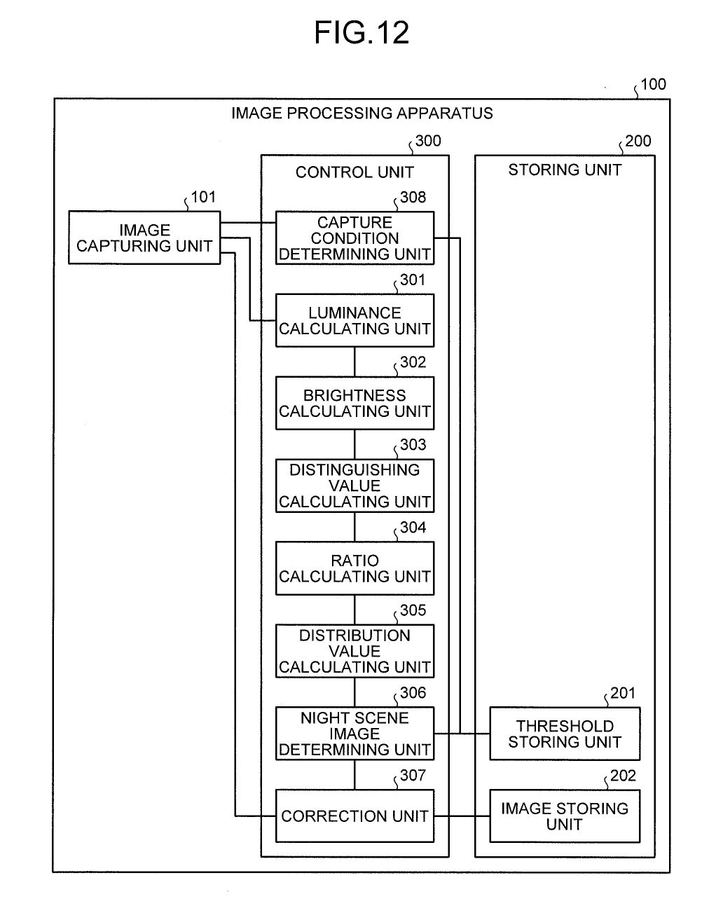

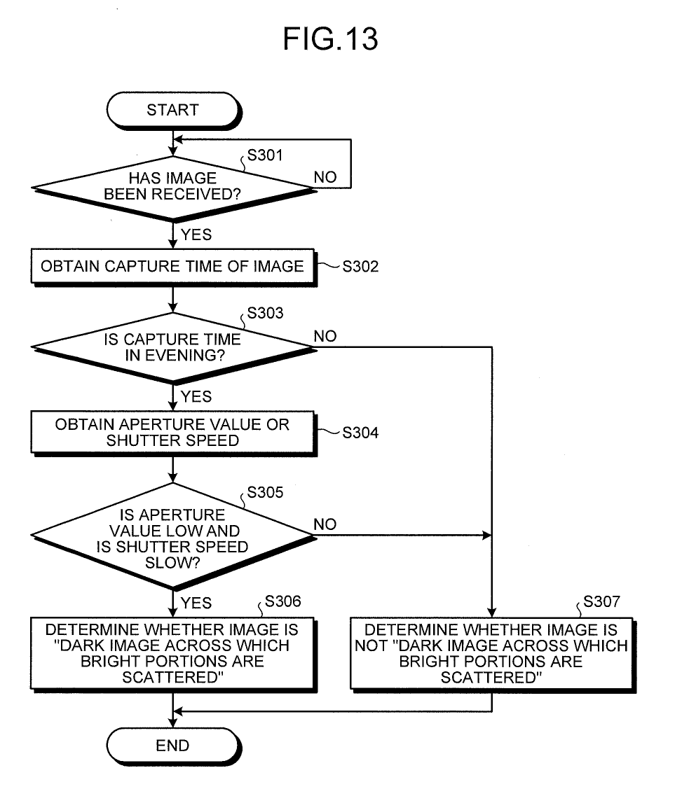

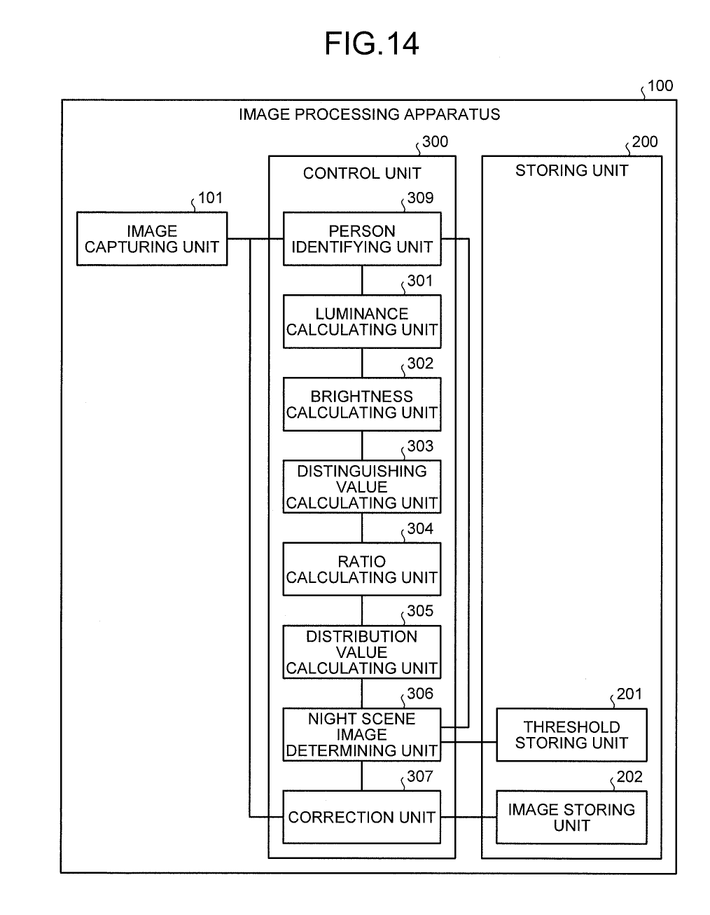

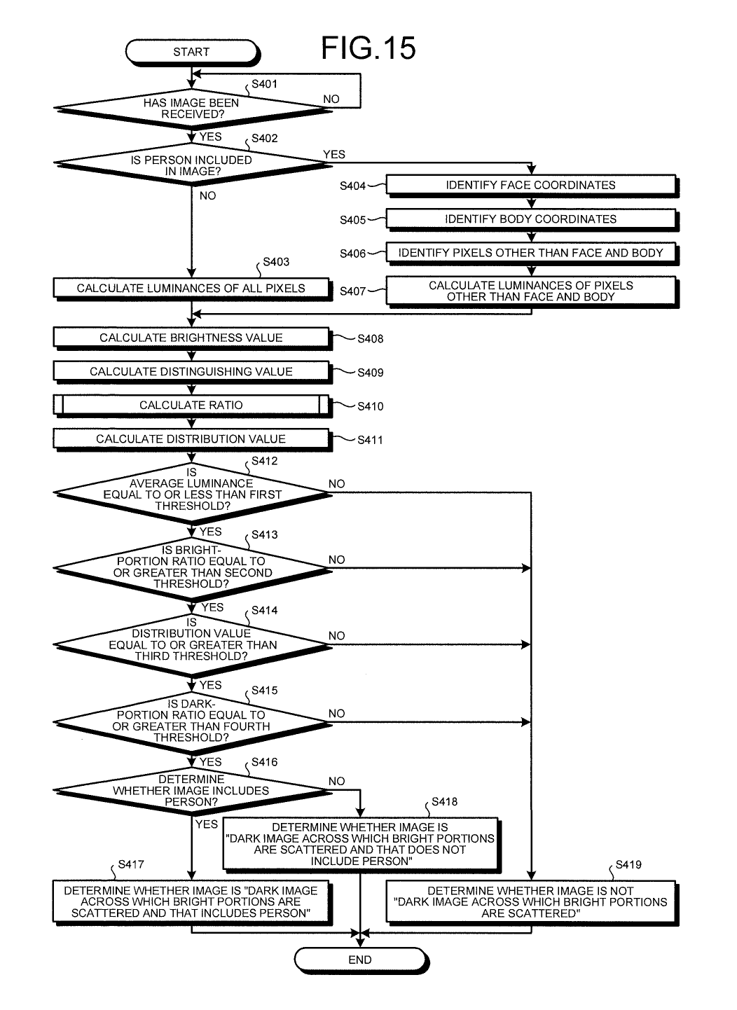

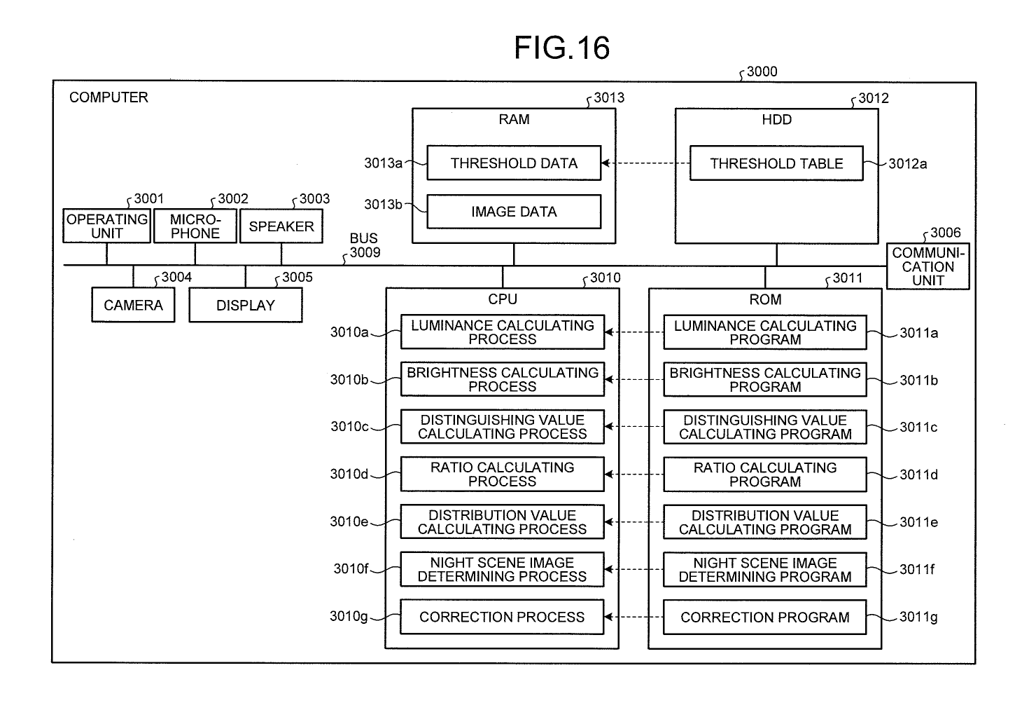

Furthermore, as illustrated in FIG. 10, according to the first embodiment, by using only luminances, it is possible to determine whether an image is a dark image across which bright portions are scattered regardless of whether a person is included in the image. Specifically, the determination may be performed regardless of whether a person is included in the center of the image as illustrated in FIG. 10A, whether a person is included in the image as illustrated in FIG. 10B, or whether a person is included on the edge of the image as illustrated in FIG. 10C. FIGS. 10A to 10C are schematic diagrams each illustrating an example of an effect of the image processing apparatus according to the first embodiment.

Furthermore, as illustrated in FIG. 11, according to the first embodiment, the determination may be performed by using only luminances regardless of whether bright portions are uniformly scattered across the entire screen as illustrated in FIG. 11A or whether bright portions are concentrated on a specific region as illustrated in FIG. 11B. FIGS. 11A and 11B are schematic diagrams each illustrating an example of an effect of the image processing apparatus according to the first embodiment. Specifically, according to the first embodiment, the determination may be performed, by using only luminances, without referring to the original image. Accordingly, even if an image is an image that is illustrated in FIG. 11B, the determination may be performed without recognizing each of the bright portions that are scattered across the image as a single point.

### [b] Second Embodiment

In the above explanation, a description has been given of the method, as the first embodiment, for performing the determining process on all of the images captured by the image capturing unit 101; however, the present embodiment is not limited thereto. For example, the determining process may be performed on only a part of the image.

Specifically, after performing a first determining process that uses the capture conditions of the image that is captured and only for an image determined to be a night scene image using the capture conditions, the night scene image determining unit 306 may also perform the determining process in a manner described in the first embodiment.

Accordingly, in the following, a method for performing the first determining process that uses the capture conditions will be described as a second embodiment. Furthermore, in the following, a description of components that are identical to those of the image processing apparatus according to the first embodiment will be described simply or will be omitted.

As illustrated in FIG. 12, the image processing apparatus 100 according to the second embodiment further includes a capture condition determining unit 308 in addition to the units included in the image processing apparatus 100 according to the first embodiment that has been described using FIG. 2.

Here, the image capturing unit 101 is connected to the capture condition determining unit 308. In addition to a captured image, the image capturing unit 101 transmits the capture conditions of the captured image to the capture condition determining unit 308. Specifically, the image capturing unit 101 transmits, as the capture conditions, to the capture condition determining unit 308, an aperture value, an ISO value, a capture time, a shutter speed, and the like.

Then, the capture condition determining unit 308 (called as an “acquiring unit” or a “capture information determining unit”) is connected to the image capturing unit 101 and the night scene image determining unit 306. Furthermore, the capture condition determining unit 308 obtains the capture conditions from the image capturing unit 101 and performs, using the obtained capture conditions, the first determining process in order to determine whether the image is captured in a dark environment. For example, if the image received from the image capturing unit 101 contains information on the capture conditions, the capture condition determining unit 308 reads the capture conditions from the image and performs the first determining process. Then, the capture condition determining unit 308 transmits the primary determination result to the night scene image determining unit 306.

Specifically, the capture condition determining unit 308 determines, using the capture conditions of the image, whether the image is captured in a dark environment. If the image is captured in a dark environment, the capture condition determining unit 308 transmits the determination result indicating that the image is possibly a night scene image to the night scene image determining unit 306. The flow of the determining process performed by the capture condition determining unit 308 will be described in detail later with reference to FIG. 13; therefore, a description thereof will be omitted here.

Furthermore, if the capture condition determining unit 308 determines that the image is possibly a night scene image, the night scene image determining unit 306 performs the determining process. In contrast, if the night scene image determining unit 306 receives the determination result indicating that the image is not a night scene image, the night scene image determining unit 306 transmits, as the determination result to the correction unit 307, information indicating that the image is not a night scene image without processing the determining process. Specifically, the night scene image determining unit 306 performs the determining process only when the capture condition determining unit 308 determines that the image is captured in a dark environment.

### Process Performed By the Image Processing Apparatus According To the Second Embodiment

An example of the flow of a process performed by the capture condition determining unit 308 according to the second embodiment will be described with reference to FIG. 13. FIG. 13 is a flowchart illustrating an example of the flow of a process performed by the image processing apparatus according to the second embodiment.

As illustrated in FIG. 13, when the capture condition determining unit 308 receives an image (Yes at Step S301), the capture condition determining unit 308 obtains a capture time of the image (Step S302). Then, the capture condition determining unit 308 determines whether the capture time is in the evening (Step S303). If the capture condition determining unit 308 determines that the capture time is 22:00, thus determining that the capture time is in the evening (Yes at Step S303), the capture condition determining unit 308 obtains, for example, an aperture value or a shutter speed (Step S304).

Then, as illustrated in FIG. 13, the capture condition determining unit 308 determines whether, for example, the aperture value is low and whether, for example, the shutter speed is slow (Step S305). If the capture condition determining unit 308 determines that the aperture value is low and that the shutter speed is slow (Yes at Step S305), the capture condition determining unit 308 determines that the image is a “dark image across which bright portions are scattered” (Step S306). Then, the night scene image determining unit 306 performs the determining process.

A case will be described in which the capture condition determining unit 308 determines that the capture time is not in the evening (No at Step S303) at Step S303 or determines that the aperture value is large and the shutter speed is fast (No at Step S305) at Step S305. In such a case, the capture condition determining unit 308 determines that the image is not a “dark image across which bright portions are scattered” (Step S307). Thereafter, the night scene image determining unit 306 does not perform the determining process. For example, the night scene image determining unit 306 transmits, as the determination result to the correction unit 307 without performing the determining process, information indicating that the image is not a “dark image across which bright portions are scattered”. Then, the correction unit 307 stores the image in the image storing unit 202 without correcting the image.

In the example illustrated in FIG. 13, an example case has been described in which the capture time, the aperture value, and the shutter speed are used; however, the present embodiment is not limited thereto. For example, it is also possible to use, for example, an ISO value or other information. Furthermore, from among the capture time, the aperture value, and the shutter speed, it is also possible to use one of the capture time, the aperture value, and the shutter speed.

### Advantage of the Second Embodiment

As described above, according to the second embodiment, the capture condition determining unit 308 obtains one or a plurality of the aperture value, the ISO value, the capture time, and the shutter speed, which all indicate the capture conditions of the captured image and determines whether, using the capture conditions, the image is captured in a dark environment. Then, only when the capture condition determining unit 308 determines that the image is captured in a dark environment, the night scene image determining unit 306 performs the determination; therefore, it is possible to precisely determine whether an image is a night scene image. Furthermore, after the determination performed by the capture condition determining unit 308, for an image that is captured in the daytime, such as an image that is apparently not a night scene image, it is possible to omit the determining process performed by the capture condition determining unit 308. Accordingly, the processing load of the night scene image determining unit 306 may be reduced.

### [c] Third Embodiment

In the first and second embodiments described above, a description has been given of the method in which the luminance calculating unit 301 uniformly performs a process on the entire image; however, the present embodiment is not limited thereto. For example, the determination may also be performed by using a portion excluding a person from an image or a correction may also be performed on a portion excluding a person from an image as a night scene image.

For example, in an image with a person captured in a dark environment, the average luminance becomes high or the dark-portion ratio becomes low because the light of a flash shines on the person. In such a case, by calculating and determining luminances in an image other than a portion in which the person is captured, it is possible to precisely determine whether the image is a night scene image.

Furthermore, a correction method suitable for an image in which a person is captured is different from a correction method for a night scene image. Accordingly, if an image is a night scene image that includes a person, when correcting the entire image by using a correction method suitable for a night scene image, the correction is not suitable for a portion in which a person is captured.

Accordingly, in the following, a description will be given of a method, as a third embodiment, for determining whether an image is a night scene image by using a portion excluding a person and correcting the portion excluding the person as a night scene image.

As illustrated in FIG. 14, the image processing apparatus 100 according to the third embodiment further includes a person identifying unit 309 that determines whether a person is captured in an image. In the example illustrated in FIG. 14, the person identifying unit 309 is connected to the image capturing unit 101, the luminance calculating unit 301, and the night scene image determining unit 306. When receiving an image from the image capturing unit 101, the person identifying unit 309 determines whether a person is captured in the received image.

For example, by using a common face recognition technology or a common face detection technology, the person identifying unit 309 determines whether a face of a person is included in an image. Then, if the person identifying unit 309 determines that a face is included in the image, the person identifying unit 309 identifies the face coordinates that specify a region occupied by the face in the image and also identifies the body coordinates that specify a region occupied by the body in the image.

Then, if the person identifying unit 309 determines that a person is captured, the person identifying unit 309 transmits, in addition to the image received from the image capturing unit 101, the face coordinates and the body coordinates to the luminance calculating unit 301 and also transmits information indicating that the image includes a person to the night scene image determining unit 306. In contrast, if the person identifying unit 309 determines that a person is not captured, the person identifying unit 309 transmits, to the luminance calculating unit 301, only the image received from the image capturing unit 101.

The luminance calculating unit 301 is connected to the person identifying unit 309 and the brightness calculating unit 302. Furthermore, if the person identifying unit 309 determines that a person is captured, the luminance calculating unit 301 identifies, from the image, pixels corresponding to the portion of the captured person and calculates luminances of pixels other than the identified pixels from among pixels constituting the image.

Specifically, when receiving the image, the face coordinates, and the body coordinates from the person identifying unit 309, the luminance calculating unit 301 identifies, from the image, pixels in a region specified by the face coordinates and the body coordinates and calculates luminances for pixels other than these identified pixels. In other words, the luminance calculating unit 301 calculates luminances for pixels corresponding to a portion other than a portion corresponding to the face and the body of the person.

Furthermore, when receiving only an image from the person identifying unit 309, the luminance calculating unit 301 performs the same processes as those described in the first embodiment.

The night scene image determining unit 306 is further connected to the person identifying unit 309. When performing the determining process, the night scene image determining unit 306 determines whether an image includes a person. For example, the night scene image determining unit 306 further determines whether information containing an image that includes a person is received from the person identifying unit 309. Then, if the night scene image determining unit 306 determines that an image is a “dark image across which bright portions are scattered” and receives information indicating that the image includes a person, the night scene image determining unit 306 determines that the image is a “dark image across which bright portions are scattered and that includes a person”. Furthermore, if the night scene image determining unit 306 determines that an image is a “dark image across which bright portions are scattered” and does not receive information indicating that the image includes a person, it determines that the image is a “dark image across which bright portions are scattered and that does not include a person.

Thereafter, if the night scene image determining unit 306 determines that the image is a “dark image across which bright portions are scattered and that includes a person”, the correction unit 307 corrects the portion in which a person is captured by using a method suitable for correcting an image in which a person is captured and corrects the portion, excluding the captured person, in an image by using a method suitable for correcting a night scene image.

For example, by using the face coordinates and the body coordinates identified by the person identifying unit 309, the correction unit 307 identifies a region specified by the face coordinates and the body coordinates in the image. Then, for a region other than the identified region, the correction unit 307 corrects the image by using the correction method for correcting a night scene image. Furthermore, the correction unit 307 identifies a region specified by the face coordinates in the image and corrects the identified region by using a method suitable for correcting a face. Furthermore, the correction unit 307 also receives the face coordinates and the body coordinates from, for example, the person identifying unit 309 or also identifies the face coordinates and the body coordinates from an image.

### Process Performed By the Image Processing Apparatus According To the Third Embodiment

In the following, the flow of a process performed by the image processing apparatus according to the third embodiment will be described with reference to FIG. 15. FIG. 15 is a flowchart illustrating an example of the flow of a process performed by the image processing apparatus according to the third embodiment. Furthermore, FIG. 15 illustrates an example flow of a process performed until the image processing apparatus determines whether an image is a night scene image or not.

As illustrated in FIG. 15, when an image is received (Yes at Step S401), e.g., when the image capturing unit 101 captures an image, the person identifying unit 309 determines whether a person is captured (Step S402). For example, by using a common face recognition technology or a common face detection technology, the person identifying unit 309 determines whether the face of a person is included in the image. If the person identifying unit 309 determines that a person is not included (No at Step S402), the luminance calculating unit 301 calculates luminances of all pixels (Step S403).

In contrast, if the person identifying unit 309 determines that a person is included (Yes at Step S402), the person identifying unit 309 identifies the face coordinates (Step S404) and also identifies the body coordinates (Step S405). Then, the luminance calculating unit 301 identifies pixels other than the face and the body (Step S406) and calculates luminances of the pixels other than the face and the body (Step S407).

If the luminance calculating unit 301 calculates the luminances (Step S403 or S407), the dark-portion ratio, the bright-portion ratio, and the distribution value are calculated (Steps S408 to S411) in the image processing apparatus 100, the average luminance. Then, the night scene image determining unit 306 determines whether an image is a night scene image (Steps S412 to S415) and further determines whether the image includes a person, (Step S416).

If the night scene image determining unit 306 determines that all of the thresholds are satisfied (Yes at Steps S412, S413, S414, S415) and determines that the image includes a person (Yes at Step S416), the night scene image determining unit 306 determines that the image is a “dark image across which bright portions are scattered and that includes a person” (Step S417). In contrast, if the night scene image determining unit 306 determines that all of the thresholds are satisfied (Yes at Steps S412, S413, S414, S415) and determines that the image does not include a person (No at Step S416), the night scene image determining unit 306 determines that the image is a “dark image across which bright portions are scattered and that does not include a person” (Step S418). Furthermore, if the night scene image determining unit 306 determines that any one of the thresholds is not satisfied (No at either Step S412, S413, S414, or S415), the night scene image determining unit 306 determines that the image is not a “dark image across which bright portions are scattered” (Step S419).

### Advantage of the Third Embodiment

As described above, according to the third embodiment, the person identifying unit 309 determines whether a person is captured in an image. If it is determined that a person is captured, the luminance calculating unit 301 identifies, from the image, each of the pixels corresponding to the portion in which the person is captured and calculates luminances of pixels other than the identified pixels from among pixels constituting the image. Accordingly, according to the third embodiment, by using luminances in a region except for a face and a body in the image to determine whether an image is a night scene image, it is possible to precisely determine whether an image is a night scene image even if the image includes a person. Furthermore, if an image includes a person, it is possible to use a correction method suitable for a region in which a person is captured or a region in which a night scene is captured.

### [d] Fourth Embodiment

Embodiments of the present embodiment have been described above; however, the present embodiment is not limited to the embodiments described above and may be implemented with various kinds of embodiments other than the embodiments described above. Accordingly, in the following, another embodiment will be described.

### Image Capturing Unit

In the first to third embodiments, a case has been described in which it is determined whether an image captured by the image capturing unit 101 is a night scene image; however, the present embodiment is not limited thereto. For example, it is also possible to determine whether an image captured by an external image capturing apparatus is a night scene image.

### Availability of the Correction

In the first embodiment, a case has been described in which the correction unit 307 that corrects an image is included; however, the present embodiment is not limited thereto and a correction unit does not have to be included. For example, after performing the determining process, the image processing apparatus may also output the determination result.

### Determining Process

Furthermore, in the first embodiment, the average luminance, the bright-portion ratio, the dark-portion ratio, and the distribution value are used; however, the present embodiment is not limited thereto. For example, the image processing apparatus may also use only the average luminance, the bright-portion ratio, and the distribution value or may also use only the bright-portion ratio, the dark-portion ratio, and the distribution value.

For example, if a “dark image that has a large bright portion” is removed by using the “average luminance”, the “dark-portion ratio” does not have to be used. Specifically, the average luminance of the “dark image that has a large bright portion” is greater than that of the “dark image across which bright portions are scattered”. Thus, for example, by setting the first threshold lower than that in the first embodiment, the image processing apparatus removes the “dark image that has a large bright portion” by using the “average luminance” and does not have to use the “dark-portion ratio”.

Furthermore, for example, by using the “dark-portion ratio” to remove the “bright image”, the “average luminance” does not have to be used. Specifically, the dark-portion ratio of the “bright image” is lower than that of the “dark image across which bright portions are scattered”. Thus, the image processing apparatus removes the “dark-portion ratio” using the “bright image” and does not have to use the “average luminance”.

### System Configuration

Furthermore, of the processes described in the embodiments, the whole or a part of the processes that are mentioned as being automatically performed may be manually performed or the whole or a part of the processes that are mentioned as being manually performed may be automatically performed using known methods. For example, the capture condition determining unit 308 may also performs the determination using the capture conditions that are manually input by a user or may perform the determination by automatically obtaining the capture conditions from an image received from the image capturing unit 101.

Furthermore, the process procedures, the control procedures, the specific names, and the information containing various kinds of data or parameters indicated in the above specification and drawings may be arbitrarily changed unless otherwise noted. For example, in the example illustrated in FIG. 13, Steps S303 and S305 may be switched.

The components of each unit illustrated in the drawings are only for conceptually illustrating the functions thereof and are not necessarily physically configured as illustrated in the drawings. In other words, the specific shape of a separate or integrated unit is not limited to the drawings; however, all or part of the unit may be configured by functionally or physically separating or integrating any of the units depending on various loads or use conditions. For example, in the example illustrated in FIG. 2, the image capturing unit 101 and the image storing unit 202 may also be separated from the image processing apparatus 100.

### Computer

The various processes described in the first embodiment may be implemented by programs prepared in advance and executed by a computer such as a personal computer or a workstation. Accordingly, in the following, a computer system that executes an image processing program having the same function as that described in the above embodiments will be described as an example using FIG. 16. FIG. 16 is a schematic diagram illustrating a computer that executes an image processing program according to the first embodiment.

As illustrated in FIG. 16, a computer 3000 according to the first embodiment includes an operating unit 3001, a microphone 3002, a speaker 3003, a display 3005, a communication unit 3006, a camera 3009, a CPU 3010, a ROM 3011, an HDD 3012, and a RAM 3013, which are all connected via a bus 3009 and the like.

The ROM 3011 stores therein, in advance, a control program having the same function as the luminance calculating unit 301, the brightness calculating unit 302, the distinguishing value calculating unit 303, the ratio calculating unit 304, the distribution value calculating unit 305, the night scene image determining unit 306, and the correction unit 307, which are all described in the first embodiment. Specifically, as illustrated in FIG. 16, the ROM 3011 stores therein, in advance, a luminance calculating program 3011a, a brightness calculating program 3011b, a distinguishing value calculating program 3011c, a ratio calculating program 3011d, a distribution value calculating program 3011e, a night scene image determining program 3011f, and a correction program 3011g. These programs 3011a to 3011g may appropriately be integrated or separated in the same manner as the components of the image processing apparatus 100 illustrated in FIG. 2.

As illustrated in FIG. 16, because the CPU 3010 reads these programs 3011a to 3011g from the ROM 3011 and executes them, these programs 3011a to 3011g function as a luminance calculating process 3010a, a brightness calculating process 3010b, a distinguishing value calculating process 3010c, a ratio calculating process 3010d, a distribution value calculating process 3010e, a night scene image determining process 3010f, and a correction process 3010g, respectively. The processes 3010a to 3010g correspond to, respectively, the luminance calculating unit 301, the brightness calculating unit 302, the distinguishing value calculating unit 303, the ratio calculating unit 304, the distribution value calculating unit 305, the night scene image determining unit 306, and the correction unit 307 illustrated in FIG. 2.

The HDD 3012 stores therein a threshold table 3012a. The threshold table 3012a corresponds to the threshold storing unit 201 illustrated in FIG. 2.

Then, the CPU 3010 reads the threshold table 3012a stores it in the RAM 3013 and executes the image processing program by using threshold data 3013a and image data 3013b stored in the RAM 3013.

### Additional

The image processing program described in the embodiment may be sent using a network such as the Internet. Furthermore, the image processing program may be stored in a computer-readable recording medium, such as a hard disc drive, a flexible disk (FD), a compact disc read only memory (CD-ROM), a magneto optical disc (MO), and a digital versatile disc (DVD). The program may also be implemented by the computer reading it from the recording medium.

According to an image processing apparatus disclosed in the present embodiment, an advantage is provided in that it is possible to determine whether an image is a dark image across which bright portions are scattered.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image processing apparatus comprising:
a luminance calculating unit that calculates luminances for pixels that make up an image;
an average calculating unit that calculates an average luminance of the luminances calculated by the luminance calculating unit;
a ratio calculating unit that identifies, from among the luminances calculated by the luminance calculating unit, each of the luminances that has a value equal to or greater than a distinguishing value that functions to distinguish a bright portion from a dark portion in the image and, that calculates a ratio of bright-portion luminances to all of the luminances calculated by the luminance calculating unit;
a distribution calculating unit that calculates, in accordance with the luminances calculated by the luminance calculating unit, a distribution value indicating a dispersion level of a luminance distribution of pixels whose luminance is equal to or greater than the distinguishing value; and
a determining unit that performs a determination determining whether the average luminance calculated by the average calculating unit is equal to or less than a first threshold, whether the bright-portion ratio calculated by the ratio calculating unit is equal to or greater than a second threshold, and whether the distribution value calculated by the distribution calculating unit is equal to or greater than a third threshold.

2. The image processing apparatus according to claim 1, wherein
the ratio calculating unit identifies, from among the luminances calculated by the luminance calculating unit, each of the luminances that has a value equal to or less than the distinguishing value and calculates a ratio of dark-portion luminances to all of the luminances calculated by the luminance calculating unit, and
the determining unit determines whether the average luminance is equal to or less than the first threshold, whether the bright-portion ratio is equal to or greater than the second threshold, whether the distribution value is equal to or greater than the third threshold, and whether the dark-portion ratio calculated by the ratio calculating unit is equal to or greater than a fourth threshold.

3. The image processing apparatus according to claim 2, wherein
the average calculating unit calculates the average luminance by using a luminance histogram of the image in accordance with the luminances calculated by the luminance calculating unit, and
the ratio calculating unit calculates the bright-portion ratio and the dark-portion ratio by using the luminance histogram of the image.

4. The image processing apparatus according to claim 3, further comprising:
an acquiring unit that acquires a capture condition of the image, the capture condition including an aperture value, an ISO value, a capture time, or a shutter speed or any combination thereof; and
a capture condition determining unit that determines, using the capture condition acquired by the acquiring unit, whether the image is captured in a dark environment, wherein
when the capture condition determining unit determines that the image is captured in the dark environment, the determining unit performs the determination using the first threshold, the second threshold, the third threshold, and the fourth threshold.

5. The image processing apparatus according to claim 4, further comprising a person identifying unit that determines whether a person is captured in the image, wherein
when the person identifying unit determines that the person is captured, the luminance calculating unit identifies, from the image, each of the pixels corresponding to a portion in which the person is captured and calculates luminances of pixels other than the identified pixels from among pixels constituting the image.

6. An image processing method comprising:
calculating luminances for pixels that make up an image;
calculating an average luminance of the luminances calculated at the luminance calculating;
identifying, from among the luminances calculated at the luminance calculating, each of the luminances that has a value equal to or greater than a distinguishing value that functions to distinguish a bright portion from a dark portion in the image and calculating a ratio of the identified bright-portion luminances to the luminances of the image;
calculating, in accordance with the luminance calculated at the luminance calculating, a distribution value indicating a dispersion level of a luminance distribution of pixels whose luminance value is equal to or greater than the distinguishing value; and
performing a determination determining whether the average luminance calculated at the average luminance calculating is equal to or less than a first threshold, whether the bright-portion ratio calculated at the bright-portion ratio calculating is equal to or greater than a second threshold, and whether the distribution value calculated at the distribution value calculating is equal to or greater than a third threshold.

7. A image processing apparatus comprising:
a memory; and
a processor coupled to the memory, wherein the processor executes a process comprising:
calculating luminances for pixels that make up an image;
calculating an average luminance of the luminances calculated at the luminance calculating;
identifying, from among the luminances calculated at the luminance calculating, each of the luminances that has a value equal to or greater than a distinguishing value that functions to distinguish a bright portion from a dark portion in the image and calculating a ratio of the identified bright-portion luminances to the luminances of the image;
calculating, in accordance with the luminance calculated at the luminance calculating, a distribution value indicating a dispersion level of a luminance distribution of pixels whose luminance value is equal to or greater than the distinguishing value; and
performs a determination determining whether the average luminance calculated at the average luminance calculating is equal to or less than a first threshold, whether the bright-portion ratio calculated at the bright-portion ratio calculating is equal to or greater than a second threshold, and whether the distribution value calculated at the distribution value calculating is equal to or greater than a third threshold.
